(19) United States
(12) Patent Application Publication
(10) Pub. No.: US 2002/0101859 A1
(43) Pub. Date: Aug. 1, 2002

(54) Communicating between nodes in different wireless networks

(76) Inventor: Ian B. Maclean, Dallas, TX (US)

Correspondence Address: TROP PRUNER & HU, PC, 8554 KATY FREEWAY, SUITE 100, HOUSTON, TX, 77024, US

(21) Appl. No.: 09/775,238

(22) Filed: Feb. 1, 2001

Related U.S. Application Data
(60) Provisional application No. 60/232,010, filed on Sep. 12, 2000.

(51) Int. Cl. H04L 12/28; H04J 3/24; H04L 12/56

(52) U.S. Cl. 370/352; 370/338; 370/349; 370/401

(57) ABSTRACT

A method and apparatus for communicating between nodes in different wireless networks includes network address translators provided between the wireless networks. The network address translators are used to translate between private addresses of network elements within each wireless network to a public address. The network address translation is performed on both a network address in a header portion in each packet transmitted across a data network between the wireless networks, as well as on network address(es) contained within the payload portion of each of the packets.

This application claims the benefit under 35 U.S.C. § 119(e) to U.S. Provisional Application Serial No. 60/232,010, entitled “a Solution For Interconnecting Roaming Partner Networks for GPRS/UMTS Service,” filed Sep. 12, 2000.

### TECHNICAL FIELD

The invention relates generally to communicating between nodes in different wireless networks.

### BACKGROUND

Mobile communications systems, such as cellular or personal communications services (PCS) systems, are made up of a plurality of cells. Each cell provides a radio communications center in which a mobile unit establishes a call with another mobile unit or wireline unit connected to a public switched telephone network (PSTN). Each cell includes a radio base station, with each base station connected to a base station controller or mobile switching center that controls processing of calls between or among mobile units or mobile units and PSTN units.

Various wireless protocols exist for defining communications in a mobile network. One such protocol is a time-division multiple access (TDMA) protocol, such as the TIA/EIA-136 standard provided by the Telecommunications Industry Association (TIA). With TIA/EIA-136 TDMA, each channel carries a frame that is divided into six time slots to support multiple (3 or 6) mobile units per channel. Other TDMA-based systems include Global System for Mobile (GSM) communications systems, which use a TDMA frame divided into eight time slots (or burst periods). Another wireless communications protocol is the code-division multiple access (CDMA) protocol, such as the IS-95A or IS-95B protocol.

Traditional speech-oriented wireless systems utilize circuit-switched connection paths in which a channel (which can be time slot of a carrier, for example) is occupied for the duration of the connection between a mobile unit and the mobile switching center. Such a dedicated connection is optimum for communications that are relatively continuous, such as speech. However, data networks such as local area networks (LANs), wide area networks (WANs), and the Internet use packet-switched communications, in which data between nodes are carried in data packets. Each node occupies the communications link only for as long as the node needs to send or receive data packets. With the rapid increase in the number of cellular subscribers in conjunction with the rising popularity of communications over data networks such as intranets or the Internet, a packet-switched wireless data connection that provides convenient and efficient access to data networks, electronic mail, databases, and other types of data has become desirable. In addition, a growing use of such data networks is for voice and other forms of real-time or streaming communications (such as video, audio and video, and so forth).

Several packet-switched wireless connection protocols have been proposed to provide more efficient connections between a mobile unit and a data network. One such protocol is the General Packet Radio Service (GPRS) protocol, which complements existing GSM systems. Another technology that builds upon GPRS is the Enhanced Data Rate for Global Evolution (EDGE) technology, which offers even higher data rates. The enhancement of GPRS by EDGE is referred to as Enhanced GPRS (EGPRS). Another variation of EGPRS is the EGPRS COMPACT technology.

While the GPRS and EGPRS technologies build upon TDMA systems such as GSM or TIA/EIA-136 systems, another wireless technology that delivers multimedia services with packet type switched communications is the UMTS (Universal Mobile Telecommunications System) technology, which is based on the Wideband CodeDivision Multiple Access (W-CDMA) protocol. Generally, while GSM, TIA/EIA-136, IS-95A, or IS-95B systems are referred to as 2G (second generation wireless systems), GPRS systems are often referred to as 2.5G systems. EGPRS and UMTS systems are referred to as 3G systems.

One of the desired services provided by wireless service providers is the ability for a mobile station to roam between different public land mobile networks (PLMNs), which are areas served by different network operators. Network operators, both national and international, enter into agreements to allow for network access when a mobile subscriber of one network operator roams into a network of another network operator (the visited PLMN).

Under GPRS, two types of support nodes are present: the serving GPRS support node (SGSN) and the gateway GPRS support node (GGSN). Generally, the SGSN manages communications with mobile stations within its service area as well as detects for new mobile stations that have entered the service area. The GGSN is used as an interface node to an external packet data network, such as an intranet or the Internet. To enable roaming of mobile stations, communications may occur between support nodes in the different PLMNs (the visited PLMN and the home PLMN). Because the communications link between different PLMNs are not as secure as private communications links between different entities within a single PLMN, the entities (and information stored in those entities) within each PLMN that participates in communications over a relatively insecure link with another PLMN becomes vulnerable to unauthorized access or attack. Consequently, there is a need for methods and apparatus to enhance the security of communications between different PLMNs.

### SUMMARY

In general, according to one embodiment, a method of communications between first and second wireless networks comprises receiving data containing a private network address of a first node in the first wireless network and translating the private network address to a public network address. Data containing the public network address translated from the private network address is sent to a second node in the second wireless network.

Some embodiments of the invention may have one or more of the following advantages. By using a public address of a core network element when communicating between different wireless networks and using a private network when communicating within a wireless network, security is enhanced since private network addresses are not exposed on a relatively insecure link between the wireless networks. By enhancing security, sensitive information, such as subscriber profiles, billing information, and the like, maintained by entities within a wireless network are protected against unauthorized access.

Other or alternative features and advantages will become apparent from the following description, from the drawings, and from the claims.

### BRIEF DESCRIPTION OF THE DRAWINGS

FIG. 1 is a block diagram of a communications system including a first wireless network and a second wireless network.

FIGS. 2 and 3 illustrate the flow of packets through various nodes in the communications system of FIG. 1.

FIGS. 4A-4B are a message flow diagram of messages between various terminals and nodes in the communications system of FIG. 1.

FIG. 5 is a block diagram of components in a border gateway (BG) including a network address translator (NAT) that can be used in the communications system of FIG. 1.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

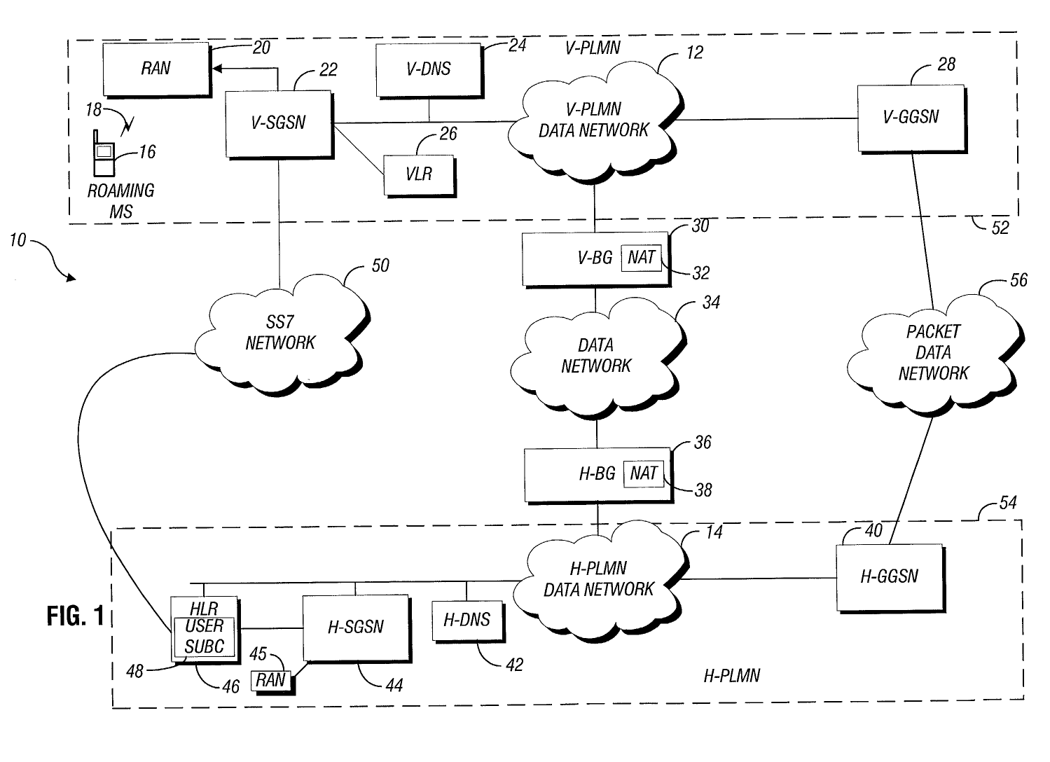

Referring to FIG. 1, a communications system 10 includes a first wireless network 52 and a second wireless network 54. The first wireless network 52 includes a public land mobile network (PLMN) that is operated by a first network operator. The second wireless network 54 includes a PLMN that is operated by a second network operator. In the illustrated example of FIG. 1, the first PLMN 52 is designated V-PLMN to indicate that it is a visited PLMN (visited by a roaming mobile station 16). On the other hand, the second PLMN 54 is referred to as the H-PLMN (or home PLMN) to indicate that it is the home of the roaming mobile station 16.

The roaming mobile station 16 communicates over radio frequency (RF) links 18 with a radio access network 20, which typically includes a base station system (implemented as a single platform or plural platforms). The radio access network 20 is connected to a serving GPRS (General Packet Radio Service) support node (SGSN) 22, which is the example is designated the V-SGSN 22. Although reference is made to GPRS in the ensuing description, the systems implemented in the first and second PLMNs 52 and 54 can alternatively be Enhanced GPRS (EGPRS) or EGPRS COMPACT systems, with the EGPRS or EGPRS COMPACT protocols defined by the European Telecommunications Standards Institute (ETSI). Alternatively, instead of a GPRS or EGPRS system, the first and second PLMNs 52 and 54 may implement a UMTS (Universal Mobile Telecommunications System) technology that is based on Wideband CDMA (W-CDMA). In a UMTS system, support nodes are also referred to as Serving General packet radio service Support Node and Gateway General packet radio service Support Node.

The V-SGSN 22 is capable of performing packet-switched communications with the roaming mobile station 16 (as well as with other mobile stations within the coverage area of the V-PLMN 52. The V-SGSN 22 is also responsible for detecting new mobile stations that have entered its service area and to establish communications with such mobile stations.

The V-SGSN 22 is coupled over a V-PLMN data network 12 (referred to as a core network or the GPRS backbone network) to a gateway GPRS support node (GGSN) 28, which is coupled to packet-based data network 56. The interface between the SGSN and GGSN in the V-PLMN 52 is referred to as the Gn Interface. A GPRS Tunneling Protocol (GTP) is used to tunnel user data and signaling between the support nodes 22 and 28 over the core network 12. GTP is described in the GSM 09.60 Specification, entitled “Digital Cellular Telecommunication System (Phase 2 Plus); General Packet Radio Service (GPRS); GPRS Tunneling Protocol (GTP) Across the Gn and Gp Interface.” GTP protocol data units (PDUs) are carried in Internet Protocol (IP) packets across the Gn interface over the core network 12.

In accordance with some embodiments of the invention, packets sent across the data network 56 are Internet Protocol (IP) packets. One version of IP is described in Request for Comments (RFC) 791, entitled “Internet Protocol,” dated September 1981; and another version of IP is described in RFC 2460, entitled “Internet Protocol, Version 6 (IPv6) Specification,” dated December 1998.

An IP network is a connectionless, packet-switched network. Packets communicated over an IP network may travel independently over any path (and possibly over different paths) to a destination point. The packets may even arrive out of order, with routing of the packets based on one or more addresses carried in each packet. Another type of packet-based data network is a connection-oriented, packet-based network, such as an Asynchronous Transfer mode (ATM) or Frame Relay network.

An IP packet typically includes a header portion and a payload portion. The payload portion carries the data that is to be communicated between network endpoints. The header portion typically includes a source network IP address (to identify the source network endpoint), a destination IP network address (to identify the destination network endpoint), and various other control information. In some examples, the packet-based data network 56 is an intranet of a company, educational organization, government agency, or some other type of enterprise. Alternatively, the packet-based data network 56 can be a public network such as the Internet.

Other elements of the V-PLMN 52 include a visitor location register (VLR) 26, which contains a local database and control and processing functions that maintain temporary records associated with network subscribers. The VLR represents a visitor's database for subscribers who are being served in a defined local area. The visitor can be a mobile subscriber being served by one of many systems in the home service area, or a subscriber who is roaming in a non-home, or visited, service area.

A domain name server (DNS) 24, referred to as the V-DNS 24, associated with the V-PLMN 52 is accessible by the V-SGSN 22. The V-DNS 24 is responsible for resolving a domain name into a network address and other associated information. Thus, for example, a client, such as the V-SGSN 22, can request a network address of an entity associated with a particular domain name. A query is passed from the client to the V-DNS 24, which returns the information to the client. Details of the Domain Name System or Server standard are described in RFC 1035, entitled “Domain Names—Implementation and Specification,” dated November 1987.

The V-PLMN 52 is coupled to the H-PLMN 54 through a data network 34. The data network 34 can be separate from, or can be part of, the packet-based data network 56. In accordance with some embodiments of the invention, a border gateway (BG) 30, referred to as the V-BG 32, is provided between the V-PLMN 52 and the data network 34, while another BG 36, referred to as the H-BG 36, is provided between the H-PLMN 54 and the data network 34. The BGs 30 and 36 contain respective network address translators (NATs) 32 and 38 to translate between public and private addresses. Thus, the NAT 32 translates between a private network address of a network element in the V-PLMN 52 and a public network address of the network element. The public address is carried in packets across the data network 34. Similarly, the NAT 38 in the H-BG 36 translates between a private network address of a network element in the H-PLMN 54 and a public network address of the H-PLMN network element. By translating a private network address to a public network address in packets communicated across the data network 34, security is enhanced since private network addresses of nodes within the first and second PLMNs 52 and 54 are not exposed outside those networks. Thus, by using private addresses in conjunction with NATs, actual identities of PLMN core network elements can be masked from the outside world. In addition to security precautions, employing private addresses within a PLMN typically allows for a more generous allotment of addresses to provision as many network elements as needed. Also, use of private addresses enables more convenient logical grouping of addresses, such as into subnets.

One of the issues associated with using network address translation is that GTP embeds network addresses within the payload portion of packets communicated across the data network 34. GTP is used to tunnel signaling and data through the Gp interface between GPRS support nodes in two different PLMNs. A NAT typically translates the source or destination address in the header of the packet. Data within the payload portion of each packet is typically not changed. However, with certain types of requests, a responding entity responds to the network address contained in the payload portion of the packet, rather than the translated network address in the header. Thus, if the network address in the payload portion of the request packet is not translated as the packet passes through a NAT, then response packets will be sent to the wrong network address and will never arrive at the requesting node.

In accordance with some embodiments of the invention, an application-level gateway (ALG) is implemented in each NAT 32 and 38 to enable the translation of network addresses embedded in payload portions of messages communicated between the first and second PLMNs 52 and 54. By modifying the network addresses embedded in the payload portion, the responding node can send a response message to the correct network address.

The H-PLMN 54 includes an H-SGSN (home SGSN) 44 that communicates with mobile stations through a radio access network 45 (which includes a base station system). The H-SGSN 44 is coupled to an H-GGSN (home GGSN) 40 through an H-PLMN data network 14. The H-GGSN 40 is the interface to the packet-based data network 56.

The H-PLMN 54 also contains a home location register (HLR) 46 that includes the primary database repository of subscriber information (indicated as 48 in FIG. 1). The HLR 46 is managed by the network operator of the H-PLMN 54 and represents the home database for subscribers who have subscribed to service in the home area. The HLR 46 contains a record for each home subscriber that includes location information, subscriber status, subscribed features, and directory numbers. The HLR subscriber information 48 also includes the following information: whether a GPRS service is subscribed to; the PDP context(s), including one or more access point names (APNs); the PDP IP address of the mobile station, if statically defined; and one or more visited PLMN Address Allowed (VAA) fields associated with corresponding APNs.

An APN is a label, in accordance with DNS naming conventions, that describes or indicates the access point to an external packet data network, such as the packet data network 56. Each subscriber may be associated with one or more APNs. For example, one APN may indicate connectivity to the Internet, while another APN may indicate connectivity to a corporate intranet. A GPRS operator may also wish to control whether a data session established by a roaming mobile station is established through the home GGSN or visited GGSN. This control is used by setting the state of the VAA field in the HLR 46. A first state of the VAA field indicates that the visited PLMN can route the data session through the visited GGSN, while a second state of VAA indicates to the visited PLMN that it is to route the data session from the visited SGSN to the home GGSN.

Thus, in the example of FIG. 1, if the roaming mobile station 16 wishes to establish a data session on the packet data network 56, the state of VAA controls whether the V-SGSN 22 provides the data session through the V-GGSN 28 or H-GGSN 40. If the data session is to occur through the H-GGSN 40, then data packets traverse the V-PLMN data network 12, V-BG 30, data network 34, H-BG 36, and H-PLMN data network 14 (collectively the Gp interface). As mentioned above, communications through this path may involve network address translation performed by the NATs 32 and 38.

There may be several reasons that a network operator may prefer to establish a data session through its home GGSN (rather than that of the visited PLMN). For example, the subscriber may be able to invoke personalized, value added services from the home GGSN that may not be supported at the visited GGSN. In addition, the home network operator may have the opportunity to leverage the services to receive more revenue and not relinquish the revenue to the roaming partner network operator.

In addition, a home DNS (H-DNS) 42 is associated with the H-PLMN 54. The H-DNS 42 is accessible by the H-SGSN 44. Additionally, the H-DNS 42 is also accessible by the V-DNS 24 to resolve domain names, such as APNs. Thus, for example, when establishing a data session for the roaming mobile station by the V-SGSN 22, if the V-DNS 24 is unable to resolve the network address of an APN associated with the roaming mobile station 16, then the V-DNS 24 may proxy the DNS request to the home DNS or H-DNS 42 associated with the H-PLMN 54 to resolve the APN.

When the roaming mobile station 16 first enters the V-PLMN 52, the V-SGSN 22 accesses the HLR 46 to retrieve the user subscription information 48 of the roaming mobile station 16. In one embodiment, this is accomplished through a Gr interface using GSM MAP (mobile application part) messaging over Signaling System Number 7 (SS7) signaling. The MAP messaging is described in the GSM 09.02 Specification, entitled “Digital Cellular Telecommunication System (Phase 2 Plus); Mobile Application Part (MAP) Specification.” The user subscription information 48 retrieved by the V-SGSN 22 is stored in the VLR 26.

For enhanced security, communications between the H-BG 36 and V-BG 30 are protected by a security protocol, such as the Internet Protocol security (IPsec) protocol. IPsec is described in part by RFC 2401, entitled “Security Architecture for the Internet Protocol,” dated November 1998. Under IPsec, an Internet Security Association and Key Management Protocol (ISAKMP) defines procedures and packet formats to establish, negotiate, and provide security services between network entities. Once the desired security services have been negotiated between two entities, such as the BGs 30 and 36, traffic is carried in IP Encapsulating Security Payload (ESP) packets. During a secure communication session between the BGs 30 and 36, transmitted data is encrypted and authentication of endpoints in the session is performed. ISAKMP is described in RFC 2408, entitled “Internet Security Associated and Key Management Protocol (ISAKMP),” dated November 1998; and ESP is described in RFC 1206, entitled “IP Encapsulating Security Payload (ESP),” dated November 1998. In other embodiments, other types of security protocols may be employed for establishing secure communications over the data network 34.

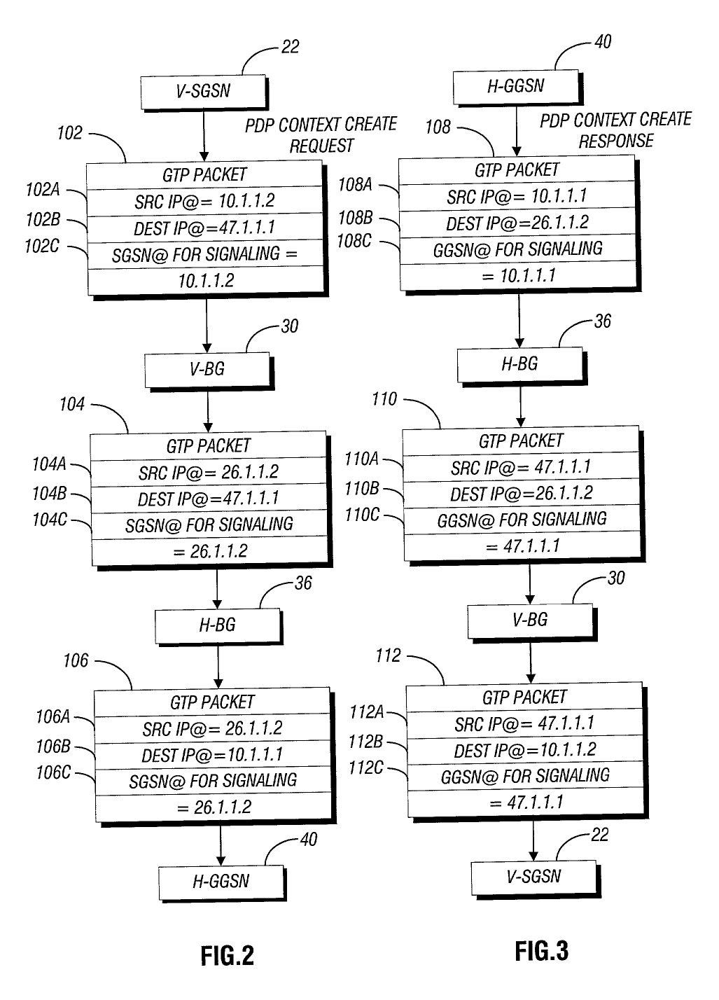

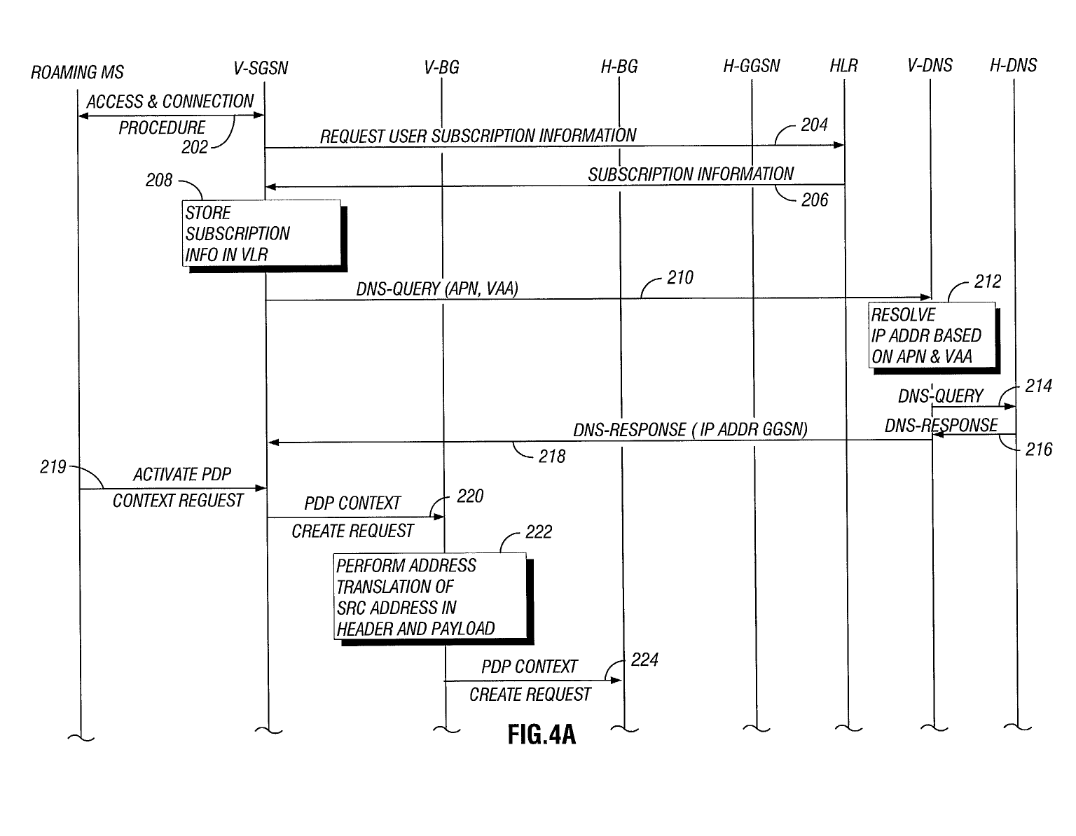

Referring to FIGS. 2 and 3, in accordance with one example, a request is sent by the V-SGSN 22 to the H-GGSN 40, which sends a response back to the V-SGSN 22. The request sent in the example is the Packet Data Protocol (PDP) Context Create request, while the response is the PDP Context Create response. In response to a request from the roaming mobile station 16 to activate a PDP context, the V-SGSN 22 sends a PDP Context Create request to the H-GGSN 40. A PDP context typically contains the following information: an identification of the PDP type, such as IP, X.25, or PPP (Point-To-Point Protocol); the PDP address; a quality-of-service (QoS) profile that identifies the requested or negotiated QoS profile for a given data flow; and other information.

The PDP Context Create request is carried in an IP packet, which is referred to as a GTP packet here because the payload portion of the IP packet 102 contains a GTP PDU (which in turn carries the PDP Context Create request). The IP packet has a source IP address 102A, a destination IP address 102B, and a payload portion 102C. In the given example, the source IP address 102A is 10.1.1.2 (which is the private IP address of the V-SGSN 22), the destination IP address 102B is 47.1.1.1 (which is the private IP address of the H-GGSN 40), and the payload portion 102C contains a field referred to as SGSN Address For Signaling, equal to 10.1.1.2, which corresponds to the private IP address of the V-SGSN 22. The address in the SGSN Address For Signaling field is the one used by the H-GGSN 40 to return the PDP Context Create response. Although specific address values are given in the example shown in FIGS. 2 and 3, such specific addresses are not intended to be limiting in any respect.

The packet 102 is communicated through the V-BG 30, which performs network address translation of the source IP address (in both the header portion 102A of the packet and the payload portion 102C of the packet). The packet 104 created by the V-BG 30 contains a translated source IP address 104A, which has been translated from 10.1.1.2 to 26.1.1.2 (private IP address to public IP address). The destination IP address 104B has the same value as the address 102B, while the value of the SGSN Address For Signaling field 104C is also converted from 10.1.1.2 to 26.1.1.2.

The packet 104 is then communicated over the data network 34 to the H-BG 36, which applies network address translation to the destination IP address. The packet 106 created by the H-BG 36 contains a source IP address 106A that remains unchanged, and a destination IP address 106B that has been translated from 47.1.1.1 to 10.1.1.1 (public destination address to private destination address). The payload portion 106C remains the same as the payload portion 104C. The packet 106 is communicated to the H-GGSN 40.

As shown in FIG. 3, the H-GGSN 40 responds to the PDP Context Create request with a PDP Context Create response. The packet 108 carrying the PDP Context Create response contains a source IP address 108A of 10.1.1.1, which is the private network address of the H-GGSN 40. The destination IP address 108B is 26.1.1.2, which is the public network address of the V-SGSN 22. The payload portion 108C contains the GGSN Address For Signaling field that is set to 10.1.1.1, which is the private network address of the H-GGSN 40.

The packet 108 is communicated to the H-BG 36, which applies network address translation to produce a packet 110. The source IP address 110A is translated from the private network address of 10.1.1.1 of the H-GGSN 40 to the public network address 47.1.1.1. The destination IP address 110B remains unchanged by the H-BG 36, while the GGSN Address For Signaling field in the payload portion 110C is also converted from the private network address 10.1.1.1 to the public network address 47.1.1.1. The packet 110 is communicated to the V-BG 30, which applies network address translation to the destination IP address. The packet 112 created by the V-BG 30 is the same as the packet 110 except that the destination IP address has been changed from 26.1.1.1 (the public network address of the V-SGSN 22) to the private network address 10.1.1.2.

In the described examples, reference is made to the PDP Content Create request and the PDP Context Create response as messages in which addresses can be embedded. In other examples, other types of messages also embed network addresses in payload portions, such as PDP Context Update, PDP Context Delete request/response and SGSN Context request/response. In yet other examples, other types of messages in which network addresses are buried in payload portions can also be used.

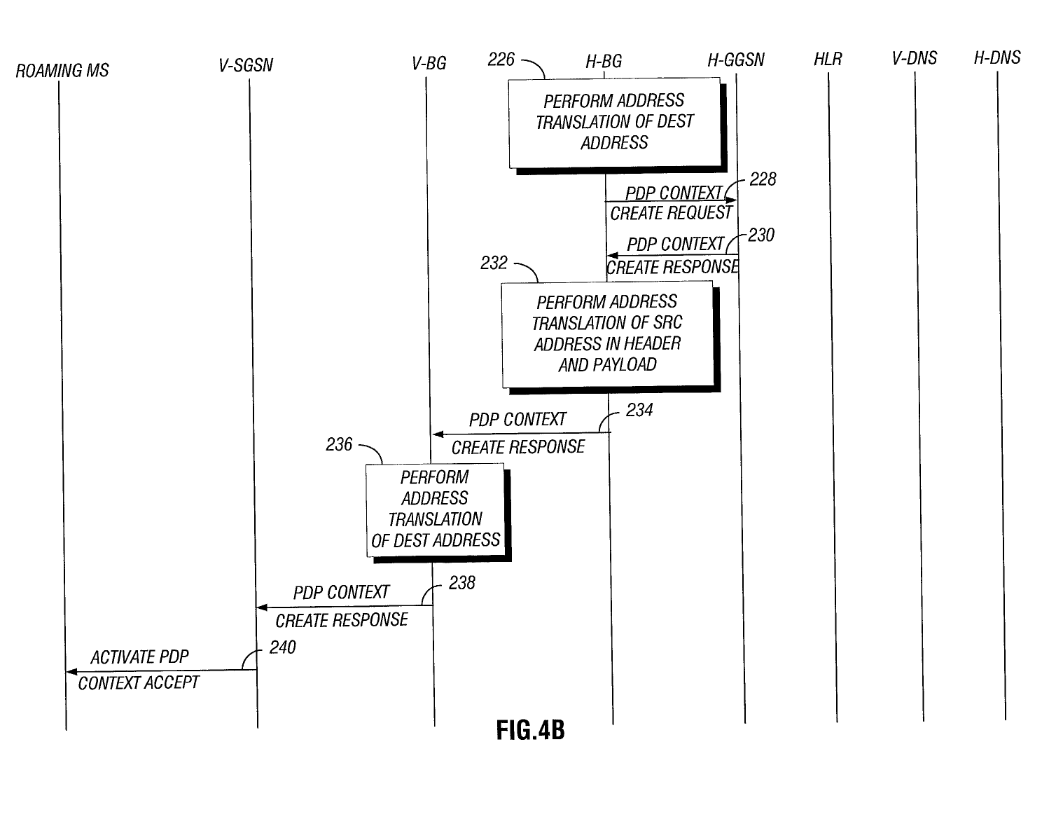

Referring to FIGS. 4A-4B, a message flow between the roaming mobile station, V-SGSN, V-BG, H-BG, H-GGSN, HLR, V-DNS, and H-DNS, according to one example, is illustrated. The roaming mobile station and V-SGSN 22 performs an access and connection procedure (at 202). As part of the access and connection procedure, the V-SGSN 22 sends a request (at 204) to the HLR 46 (in the H-PLMN 54) over the SS7 network 50 (FIG. 1) to request user subscription information. The HLR 46 returns the subscription information (at 206) back to V-SGSN 22. The V-SGSN 22 stores the subscription information (at 208) into the VLR 26.

In addition, the V-SGSN 22 sends a DNS-query (at 210) to the V-DNS 24. The DNS-query contains an APN (specifying the access point to the packet data network 56) and the associated VAA 40 for a data session to be established on the packet data network 56 on behalf of the roaming mobile station 16. The V-DNS 24 resolves (at 212) the IP network address based on the APN value and the state of VAA. If the VAA field has a first state, then the APN is resolved to the IP address of the V-GGSN 28. However, if the VAA field has a second state, then the APN is resolved to the IP address of the H-GGSN 40. As noted above, the state of VAA controls whether the data session requested by the roaming mobile station 16 is provided through the visited GGSN or the home GGSN. If the V-DNS 24 is unable to resolve the APN, then it proxies the DNS query by sending a DNS query (at 214) to the H-DNS 42 (or to another DNS). The H-DNS 42 returns a DNS-response (at 216) back to the V-DNS 24.

Once the V-DNS has the IP address information based on the received APN and VAA values, the V-DNS 24 sends (at 218) a DNS-response back to the V-SGSN 22. The DNS-response contains the IP address of the GGSN to use for the data session. In this example, the GGSN is assumed to be the H-GGSN 40.

As part of the access and connection procedure at 202, the roaming mobile station also sends (at 219) an Activate PDP Context request to the V-SGSN 22. In response to this request, the V-SGSN 22 sends a PDP Context Create request (at 220), which is targeted at the H-GGSN 40. When the V-BG 30 receives the packet containing the PDP Context Create request, it performs (at 222) address translation of the source address in both the header and payload portions of the packet. After network address translation, the V-BG 30 sends the PDP Context Create request (at 224) over the data network 34 to the H-BG 36. The H-BG 36 performs (at 226) address translation of the destination address contained in the header of the packet. The H-BG 36 then forwards the PDP Context Create request (at 228) to the H-GGSN 40.

In response to the PDP Context Create request, the H-GGSN 40 sends a PDP Context Create response (at 230), which is targeted back to the V-SGSN 22. When the H-PG 36 receives the PDP Context Create response, it performs (at 232) network address translation of the source address in both the header and payload portions (at 232). After network address translation, the H-BG 36 sends the PDP Context Create response (at 234) to the V-BG 30. The V-BG 30 performs (at 236) network address translation of the destination address in the packet. After the destination network address translation, the V-BG 36 sends the PDP Context Create response (at 238) to the V-SGSN 22. Upon receipt of the PDP Context Create response, the V-SGSN send an Activate PDP Context Accept indication (at 240) back to the roaming mobile station 16 through the radio access network 20.

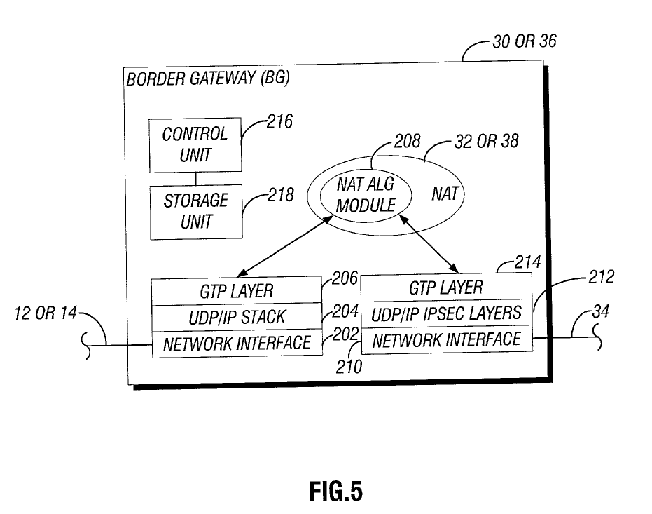

Referring to FIG. 5, components of the border gateway 30 or 36, according to one example embodiment, are illustrated. The border gateway 30 or 36 contains a first network interface 202, which is coupled to communicate with the PLMN data network 12 or 14. Above the network interface 202 is a UDP/IP (User Datagram Protocol/Internet Protocol) stack 204. UDP is described in RFC 768, entitled “User Datagram Protocol,” dated August 1980, and provides a transport layer for managing connections between network elements over an IP network. Above the UDP/IP stack 204 is a GTP layer 206, which performs GTP functions for communications between an SGSN and a GGSN. The NAT 32 or 38 is coupled to the GTP layer 206 to receive or transmit messages. The NAT 32 or 38 performs network address translation of the source or destination address in the header portion of IP packets. In addition, the NAT 32 or 38 also contains a NAT ALG module 208 that performs network translation of addresses carried in the payload portion of an IP packet. The NAT ALG module 208 accomplishes this by searching for a specific network address string in the payload portion and converting the string to the appropriate network address value. The NAT ALG module 208 is shown as being part of the NAT 32 or 38. Alternatively, the NAT ALG module 208 can be a separate component.

To communicate over the data network 34, the NAT 32 or 38 and the NAT ALG module 208 are coupled to a stack including a network interface 210, UDP/IP and IPsec layers 212, and a GTP layer 214. The IPsec layer 212 contains ISAKMP and ESP modules. The network interface 210 is coupled to communicate over the data network 34.

The various software layers, routines, or modules described herein may be executable on various processing elements, such as the control unit 216 in the border gateway. Each control unit includes a microprocessor, a microcontroller, a processor card (including one or more microprocessors or microcontrollers), or other control or computing devices. As used here, a “controller” can refer to either hardware or software or a combination of the two. A “controller” can also refer to a single component or to plural components (either hardware or software).

A storage unit includes one or more machine-readable storage media for storing data and instructions. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs or digital video disks (DVDs). Instructions that make up the various software layers, routines or modules in the various network elements are stored in respective storage units. The instructions when executed by a respective control unit cause the corresponding system to perform programmed acts.

The instructions of the software layers, routines or modules are transported to the system in one of many different ways. For example, code segments including instructions stored on floppy disks, CD or DVD media, a hard disk, or transported through a network interface card, modem, or other interface device are loaded into the system and executed as corresponding software layers, routines, or modules. In the loading or transport process, data signals that are embodied in carrier waves (transmitted over telephone lines, network lines, wireless links, cables, and the like) communicate the code segments, including instructions, to the network element. Such carrier waves are be in the form of electrical, optical, acoustical, electromagnetic, or other types of signals.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of communications between first and second wireless networks, comprising:
receiving data containing a private network address of a first node in the first wireless network;
translating the private network address to a public network address; and
sending data containing the public network address translated from the private network address to a second node in the second wireless network.

2. The method of claim 1, wherein the received data comprises a data packet, and wherein translating the private network address comprises translating the private network address in a header of the data packet.

3. The method of claim 2, wherein translating the private network address further comprises translating the private network address in a payload portion of the data packet.

4. The method of claim 1, wherein receiving data comprises receiving data containing a General Packet Radio Service Tunneling Protocol data unit.

5. The method of claim 1, wherein receiving data comprises receiving data from a Serving General packet radio service Support Node in the first wireless network, the first node comprising the Serving General packet radio service Support Node.

6. The method of claim 5, wherein sending data comprises sending data to a Gateway General packet radio service Support Node, the second node comprising the Gateway General packet radio service Support Node.

7. The method of claim 1, further comprising determining whether to establish a data session on a packet data network on behalf of a roaming mobile station through the first wireless network or the second wireless network.

8. The method of claim 7, wherein the receiving, translating, and sending acts are performed by a network element between the first and second wireless networks.

9. The method of claim 1, wherein the translating is performed by a network address translator.

10. An article comprising at least one storage medium containing instructions that when executed cause a system to:
receive a packet having a header portion and a payload portion from a first node in a first wireless network, the payload portion containing a private network address of the first node;
translate the private network address in the header portion and in the payload portion to a public network address; and
send the packet containing the public network address to a second node in a second wireless network.

11. The article of claim 10, wherein the instructions when executed cause the system to send the packet containing the public network address in the header portion of the packet and the payload portion of the packet.

12. The article of claim 10, wherein the instructions when executed cause the system to translate the private network address in the payload portion by identifying a string in the payload portion containing the private network address.

13. The article of claim 10, wherein the instructions when executed cause the system to receive the packet containing General Packet Radio Service Tunneling Protocol data.

14. The article of claim 10, wherein the instructions when executed cause the system to receive the packet from a Serving General packet radio service Support Node in the first wireless network, the first node comprising the General Packet Radio Service support node.

15. The article of claim 14, wherein the instructions when executed cause the system to send the packet to a Gateway General packet radio service Support Node in a second wireless network.

16. The article of claim 15, wherein the instructions when executed cause the system to receive the packet from the Serving General packet radio service Support Node associated with a first public land mobile network and to send the packet to the Gateway General packet radio service Support Node associated with a second public land mobile network.

17. The article of claim 10, wherein the instructions when executed cause the system to receive the packet from the first wireless network associated with a first network operator and to send the packet to a node in a second wireless network associated with a second network operator.

18. A system comprising:
an interface to a first wireless network, the interface adapted to receive a data packet containing a header portion and a payload portion, the payload portion containing a first network address of a node in the first wireless network; and
a network address translator module adapted to translate the first network address to a second, different network address associated with the node.

19. The system of claim 18, further comprising a controller adapted to send the data packet containing the second network address to a second wireless network.

20. The system of claim 19, wherein the first wireless network is associated with a first network operator and the second wireless network is associated with a second network operator.

21. The system of claim 18, wherein the interface is adapted to receive the data packet comprising an Internet Protocol packet.

22. The system of claim 21, further comprising a controller adapted to send the data packet containing the second network address to a second wireless network, the data packet comprising an Internet Protocol packet.

23. The system of claim 18, wherein the interface is adapted to receive the data packet having a General Packet Radio Service Tunneling Protocol data unit in the payload portion of the data packet.

24. The system of claim 18, wherein the first network address comprises a private network address of the node, and wherein the second network address comprises a public network address of the node.

25. A data signal embodied in a carrier wave and comprising instructions that when executed cause a system to:
perform one-to-one translation of a private network address and a public network address in a packet received from a first wireless network, the private and public network addresses associated with a node in the first wireless network; and
send the packet with a translated network address to a second wireless network.
